(19) United States
(12) Patent Application Publication
(10) Pub. No.: US 2022/0343664 A1
(43) Pub. Date: Oct. 27, 2022

(54) IMAGE PROCESSING APPARATUS, IMAGE PROCESSING METHOD, AND RECORDING MEDIUM

(71) Applicant: CANON KABUSHIKI KAISHA, Tokyo (JP)

(72) Inventor: Keisuke Ito, Tokyo (JP)

(21) Appl. No.: 17/719,185

(22) Filed: Apr. 12, 2022

(30) Foreign Application Priority Data
Apr. 22, 2021 (JP) 2021-072754

(51) Int. Cl. G06V 30/18; G06F 16/16

(52) U.S. Cl. CPC G06V 30/18; G06F 16/164; G06F 16/168

(57) ABSTRACT

An image processing apparatus includes a unit configured to acquire image data, a unit configured to perform a character recognition process on the acquired image data to detect a character string, and create a folder path indicating a storage destination of the acquired image data including one or more of the detected character strings, and a unit configured to determine whether or not each of the character strings forming the created folder path is a character string representing a specific folder name, determine whether or not a certainty factor of a result of the character recognition process for a character string determined as not being a character string representing the specific folder name is equal to or less than a threshold value, and if there is at least one character string for which determination of being equal to or less than the threshold value has been made, set the created folder path as a target for checking by a user.

### BACKGROUND OF THE INVENTION

### Field of the Invention

The present invention relates to an image processing apparatus, an image processing method, and a recording medium.

### Description of the Related Art

In the related art, form data scanned and digitized by a multifunction peripheral (MFP) or the like may be stored and managed in a storage. In this case, there is a technique in which a character string described in a form image is read, the character string is compared with a character string representing a folder path of a storage stored in advance, and folders that are storage destinations of an image are switched therebetween according to a matching part (for example, Japanese Patent Laid-Open No. 2019-117622).

When storing digitized image data in a storage, a file name given to the data and a folder path of a storage destination of the data may be automatically created on the basis of a character string extracted from a specific region in a form. In that case, a user sets in advance a rule for how to combine character strings written in regions in the form to create a file name and a folder path. A rule is prepared for each form type that can be classified by a system.

In order to create a file name and a folder path, a form classification process and a character recognition process are performed on a scanned image, required character strings are extracted from a form, and then the character strings are combined according to a rule corresponding to a form type. In this case, the character recognition process includes a character string extraction process of extracting a region where a character string that is an extraction target is present from an image and an OCR process of finding characters from the extracted character string region and converting the characters into text data. OCR stands for optical character recognition.

In the above system, a user checks whether the created file name and folder path are correct on a screen of an MFP or a personal computer (PC), approves the file name and the folder path, and then transmits a file to an external storage. If the obtained character string is incorrect, the user corrects the character string to a correct character string, approves the file name and the folder path, and transmits a file. Such checking work is burdensome work for the user. In contrast, it is conceivable that, if it can be determined that a created file name and folder path are certain, a process of automatically transmitting an image file to an external storage (automatic transmission process) is executed without requesting checking to a user. In this case, the certainty of the file name and the folder path is evaluated by evaluating the certainty of a character string extracted from a specific region in a form, configuring them. In order to evaluate the certainty, a value called a certainty factor obtained in association with results of the character string region extraction process and the OCR process performed when extracting a character string is used. The greater a value of the certainty factor, the higher a probability that a processing result is correct. Therefore, when a certainty factor of results of the character string extraction process and the OCR process is equal to or more than a preset threshold value, it can be determined that a character string extracted from a specific region in the form is certain, and as a result, it can be determined that the file name and the folder path are also certain. However, if a certainty factor of an OCR result of at least some characters of the extracted character string is low, the user needs to check it.

On the other hand, if a middle part of the folder path created on the basis of the OCR result matches a folder path approved by the user in the past, it is highly likely that the matching part is a correct folder path. However, if a folder path is set as a checking target when a certainty factor of an OCR result of at least some characters is low, even if a folder path created on the basis of the OCR result matches a folder path approved by the user in the past, when the certainty factor is low, the folder path is a checking target.

### SUMMARY OF THE INVENTION

The present invention improves efficiency of a process of handling image data.

According to an embodiment of the present invention, there is provided an image processing apparatus including a unit configured to acquire image data, a unit configured to perform a character recognition process on the acquired image data to detect a character string, and create a folder path indicating a storage destination of the acquired image data including one or more of the detected character strings, and a unit configured to determine whether or not each of the character strings forming the created folder path is a character string representing a specific folder name, determine whether or not a certainty factor of a result of the character recognition process for a character string determined as not being a character string representing the specific folder name is equal to or less than a threshold value, and if there is at least one character string for which determination of being equal to or less than the threshold value has been made, set the created folder path as a target for checking by a user.

Further features of the present invention will become apparent from the following description of exemplary embodiments with reference to the attached drawings.

### BRIEF DESCRIPTION OF THE DRAWINGS

FIG. 1 is a diagram illustrating an overall configuration of an image processing system according to a first embodiment of the present invention.

FIG. 2 is a hardware configuration diagram of an MFP.

FIG. 3 is a hardware configuration diagram of a client PC and an MFP cooperation service.

FIG. 4 is a software configuration diagram of the image processing system according to the first embodiment of the present invention.

FIGS. 5A and 5B are sequence diagrams illustrating a flow of processes between respective apparatuses.

FIG. 6 is a diagram illustrating a screen for setting a file name and folder path.

FIG. 7 is a diagram illustrating an example of a data structure to be stored in an analysis result storage process performed by an image processing unit in the present system.

FIG. 8 is a flowchart illustrating details of a process for evaluating the certainty of a folder path, performed by the image processing unit in the present system.

FIG. 9 is a flowchart illustrating details of threshold value processing executed when the image processing unit in the present system evaluates the certainty of a folder path.

FIG. 10 is a flowchart illustrating details of threshold value processing executed when an image processing unit in a second embodiment evaluates the certainty of a folder path.

FIG. 11 is a flowchart illustrating details of threshold value processing executed when an image processing unit in a third embodiment evaluates the certainty of a folder path.

FIG. 12 is a flowchart illustrating details of threshold value processing executed when an image processing unit in a fourth embodiment evaluates the certainty of a folder path.

FIG. 13 is a flowchart illustrating details of threshold value processing executed when the image processing unit in the fourth embodiment evaluates the certainty of a folder path.

FIG. 14 is a flowchart illustrating details of a process executed when an image processing unit in a fifth embodiment evaluates the certainty of a folder path.

FIG. 15 is a flowchart illustrating details of threshold value processing executed when the image processing unit in the fifth embodiment evaluates the certainty of a folder path.

### DESCRIPTION OF THE EMBODIMENTS

Hereinafter, embodiments of the present invention will be described with reference to the drawings. It should be noted that the following embodiments do not limit the invention according to the claims, and not all combinations of features described in the embodiments are essential for the means for solving the invention.

### First Embodiment

Overall Configuration

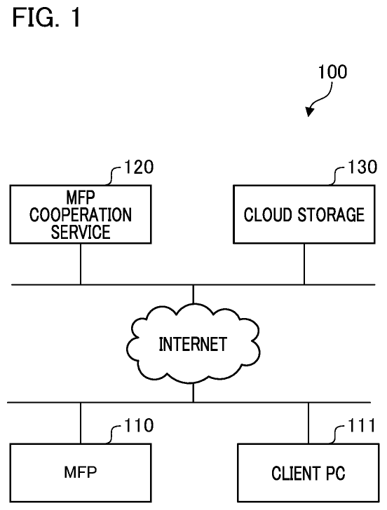

FIG. 1 is a diagram illustrating an overall configuration of an image processing system according to a first embodiment of the present invention. An image processing system 100 includes an MFP 110, a client PC 111, an MFP cooperation service 120, and a cloud storage 130. The MFP 110 and the client PC 111 are communicatively connected to a server that provides various services on the Internet via a local area network (LAN).

The MFP 110 is a multifunction apparatus having a plurality of functions such as those of a scanner and a printer, and is an example of an image processing apparatus. The client PC 111 is a computer or an application that receives a service requested to the MFP cooperation service 120. The MFP cooperation service 120 is an example of a service having a function of storing an image file scanned by the MFP 110 on its own server or transferring the image file to a service such as another storage service capable of storing a file. The cloud storage 130 is a service that can save a file via the Internet and acquire a file with a web browser.

The image processing system 100 of the present embodiment has a configuration including the MFP 110, the client PC 111, the MFP cooperation service 120, and the cloud storage 130, but the present invention is not limited thereto. For example, the MFP 110 may also serve as the client PC 111 and the MFP cooperation service 120. The MFP cooperation service 120 may be in a connection form disposed on a server on a LAN instead of on the Internet. The cloud storage 130 may be replaced with a mail server or the like, and a scanned image may be attached to a mail and transmitted.

Hardware Configuration of MFP

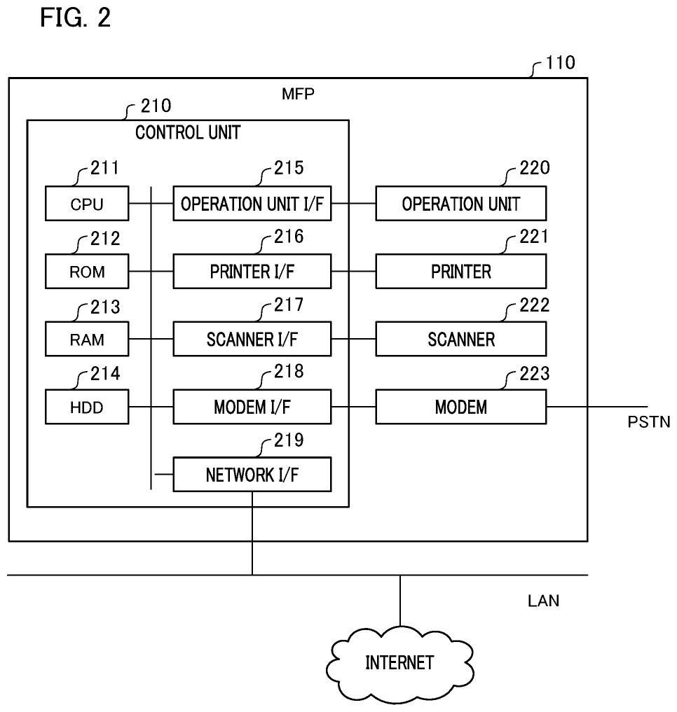

FIG. 2 is a hardware configuration diagram of the MFP 110. The MFP 110 includes a control unit 210, an operation unit 220, a printer unit 221, a scanner unit 222, and a modem 223. The control unit 210 includes a CPU 211. CPU stands for central processing unit. The control unit 210 includes a ROM 212. ROM stands for read only memory. The control unit 210 includes a RAM 213. RAM stands for random access memory. The control unit 210 includes an HDD 214. HDD stands for hard disk drive. The control unit 210 includes an operation unit I/F 215, a printer I/F 216, a scanner I/F 217, a modem I/F 218, and a network I/F 219. I/F stands for interface. The control unit 210 controls an operation of the entire MFP 110.

The CPU 211 reads a control program stored in the ROM 212 and executes and controls various functions of the MFP 110 such as reading, printing, and communication. The RAM 213 is used as a temporary storage region for a main memory, a work area, and the like of the CPU 211. In the present embodiment, a single CPU 211 uses a single memory (the RAM 213 or the HDD 214) to execute each process illustrated in a flowchart that will be described later, but the present invention is not limited thereto. For example, a plurality of CPUs, a plurality of RAMs, or HDDs may be linked to execute each process. The HDD 214 is a large-capacity storage unit that stores image data and various programs.

The operation unit I/F 215 is an interface that connects the operation unit 220 to the control unit 210. The operation unit 220 is provided with a touch panel, a keyboard, and the like, and receives operations, inputs, and instructions from a user.

The printer I/F 216 is an interface that connects the printer unit 221 to the control unit 210. Printing image data is transferred from the control unit 210 to the printer unit 221 via the printer I/F 216 and printed on a recording medium.

The scanner I/F 217 is an interface that connects the scanner unit 222 to the control unit 210. The scanner unit 222 reads an original set on a platen (not illustrated) or an auto document feeder (ADF) to generate image data, and inputs the image data to the control unit 210 via the scanner I/F 217. The MFP 110 can print out (copy) the image data generated by the scanner unit 222 from the printer unit 221, and can also transmit a file of the image data or transmit the image data by email.

The modem I/F 218 is an interface that connects the modem 223 to the control unit 210. The modem 223 facsimiles and communicates image data with a facsimile machine on the public switched telephone network (PSTN).

The network I/F 219 is an interface that connects the control unit 210 (MFP 110) to the LAN. The MFP 110 uses the network I/F 219 to transmit image data and information to each service on the Internet, and to receive various types of information.

Hardware Configurations of Client PC and MFP Cooperation Service

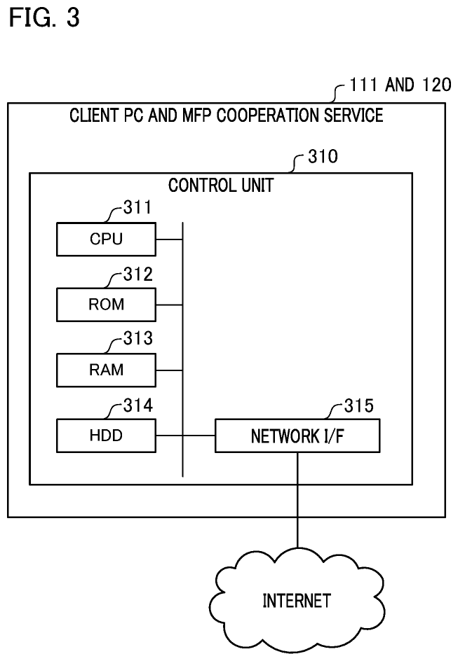

FIG. 3 is a hardware configuration diagram of the client PC 111 and the MFP cooperation service 120. Each of the client PC 111 and the MFP cooperation service 120 includes a CPU 311, a ROM 312, a RAM 313, an HDD 314, and a network I/F 315.

The CPU 311 controls the entire operation by reading a control program stored in the ROM 312 and executing various processes. The RAM 313 is used as a temporary storage region for the main memory, a work area, and the like of the CPU 311. The HDD 314 is a large-capacity storage unit that stores image data and various programs. The network I/F 315 is an interface that connects the MFP cooperation service 120 to the Internet. The MFP cooperation service 120 and the cloud storage 130 receive a processing request from apparatuses (such as the MFP 110) via the network I/F 315 and transmit and receive various types of information.

Software Configuration of Image Processing System

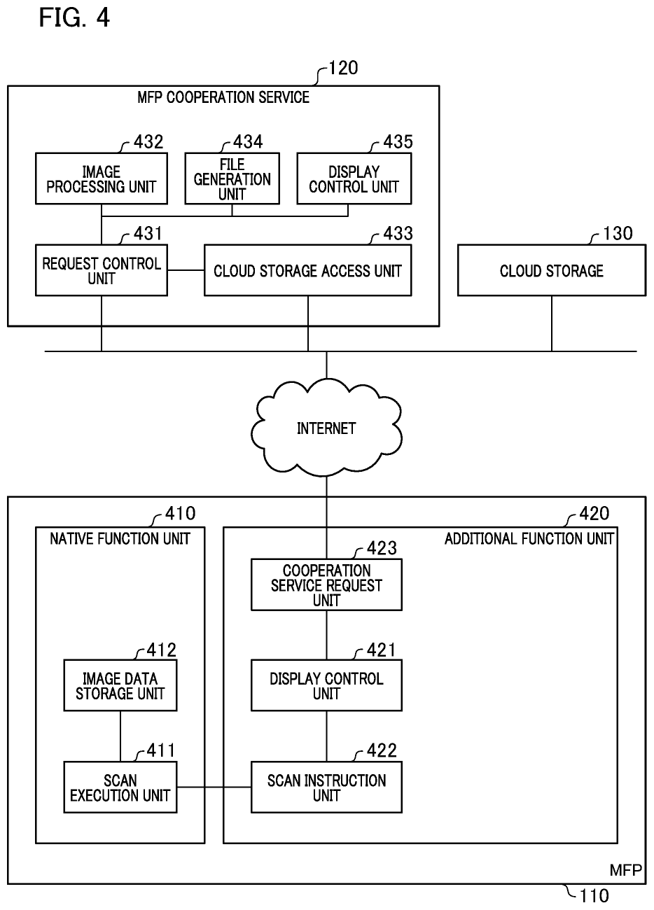

FIG. 4 is a software configuration diagram of the image processing system according to the present embodiment. The MFP 110 may be roughly divided into two such as a native function unit 410 and an additional function unit 420. Each unit included in the native function unit 410 is provided as standard in the MFP 110. In contrast, the additional function unit 420 is an application additionally installed in the MFP 110. The additional function unit 420 is an application based on Java, and can easily realize addition of functions to the MFP 110. Other additional applications (not illustrated) may be installed in the MFP 110.

The native function unit 410 has a scan execution unit 411 and an image data storage unit 412. The additional function unit 420 has a display control unit 421, a scan instruction unit 422, and a cooperation service request unit 423.

The display control unit 421 displays a UI screen for accepting operations from a user on a liquid crystal display unit having a touch panel function of the operation unit 220 of the MFP 110. UI stands for user interface. The display control unit 421 displays UI screens such as a screen for inputting authentication information for accessing the MFP cooperation service 120, performing scan settings, and performing a scan start operation, a preview screen, and a screen for setting a file name and a folder path of a storage destination of a file.

The scan instruction unit 422 requests the scan execution unit 411 to perform a scan process together with the scan settings corresponding to a user instruction input via the UI screen. The scan execution unit 411 receives a scan request including scan settings from the scan instruction unit 422. The scan execution unit 411 generates scanned image data by scanning an original placed on a platen glass with the scanner unit 222 via the scanner I/F 217 in response to the scan request. The generated scanned image data is sent to the image data storage unit 412. The scan execution unit 411 sends a scanned image identifier uniquely indicating the stored scanned image data to the scan instruction unit 422. The scanned image identifier is a number, a symbol, a letter, or the like (not illustrated) for uniquely identifying the scanned image in the MFP 110. The image data storage unit 412 stores the scanned image data received from the scan execution unit 411 in the HDD 214. The scan instruction unit 422 acquires the scanned image data corresponding to the scanned image identifier received from the scan execution unit 411 from the image data storage unit 412. The scan instruction unit 422 requests, to the cooperation service request unit 423, an instruction for processing the acquired scanned image data in the MFP cooperation service 120.

The cooperation service request unit 423 requests various processes to the MFP cooperation service 120. The cooperation service request unit 423 makes requests for logging in, analysis of a scanned image, transmission of a scanned image, and the like. Communication between the cooperation service request unit 423 and the MFP cooperation service 120 is performed by using a protocol such as REST or SOAP, but other communication means may also be used. REST stands for Representational State Transfer. SOAP stands for Simple Object Access Protocol.

The MFP cooperation service 120 includes a request control unit 431, an image processing unit 432, a cloud storage access unit 433, a file generation unit 434, and a display control unit 435.

The request control unit 431 is on standby in a state in which it can receive a request from an external device. Upon receiving a processing request, the image processing unit 432, the cloud storage access unit 433, and the file generation unit 434 are instructed to perform processing as appropriate in response to the request.

The image processing unit 432 performs a form classification process, a character recognition process including a character string region extraction process and an OCR process that will be described later, a recognition process for an image such as image rotation and tilt correction, and an image processing process. That is, the character recognition process includes the character string region extraction process and the OCR process. The character recognition process detects a character string by finding characters. The image processing unit 432 creates a folder path for an image including one or more character strings detected through the character recognition process.

The cloud storage access unit 433 makes a request for a process for a cloud storage. Cloud services generally use protocols such as REST and SOAP to publish various interfaces for storing files in the cloud storage and acquiring stored files. The cloud storage access unit 433 operates the cloud storage by using a published cloud storage interface.

The file generation unit 434 generates an image file. The display control unit 435 receives a request from a web browser operating on another terminal (not illustrated) such as a PC or a mobile terminal connected via the Internet, and returns screen configuration information (HTML, CSS, or the like) required for screen display. The user checks user information registered in the MFP cooperation service 120 via the screen displayed on the web browser, or changes a setting at the time of scanning.

Although FIG. 4 has described an example of a configuration in which the additional function unit 420 is installed in the MFP 110, the present invention is not limited to this configuration, and the client PC 111 may have the function of the additional function unit 420.

Overall Process Flow

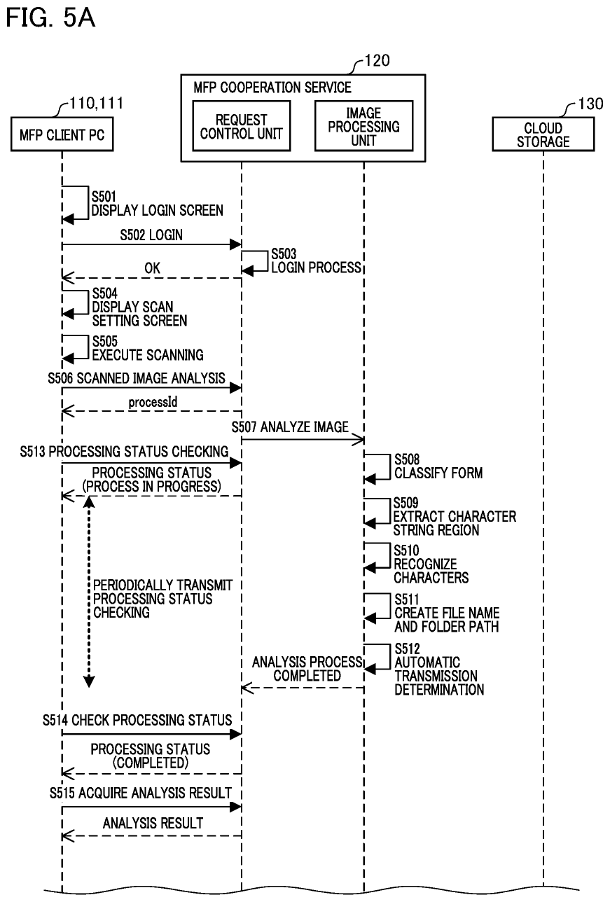

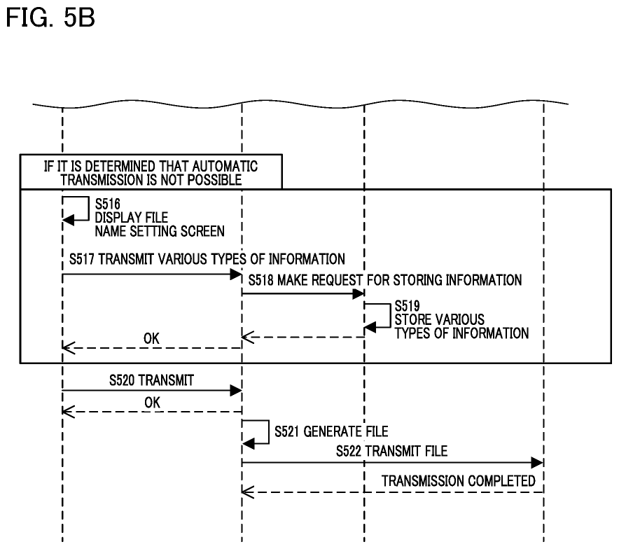

FIGS. 5A and 5B are sequence diagrams illustrating a flow of processes between respective apparatuses when an image scanned by the MFP 110 is converted into a file and transmitted to the cloud storage. Here, communication between the respective apparatuses will be mainly described. Although it is described in FIGS. 5A and 5B that the MFP 110 communicates with the MFP cooperation service 120, the client PC 111 may execute analysis result acquisition, screen display, learning instruction, and the like that will be described later, instead of the MFP 110.

The MFP 110 displays a main screen in which buttons for performing each function provided in a normal state are arranged on the touch panel. By installing an additional application (hereinafter, referred to as a scan application) for transmitting a scan form to the cloud storage in the MFP 110, a button for using a function of the application is displayed on the main screen of the MFP 110. When this button is pressed, a screen for transmitting the scanned form to the cloud storage is displayed, and the processes illustrated in the sequences in FIGS. 5A and 5B are performed.

In step S501, the MFP 110 displays a login screen for inputting authentication information for accessing the MFP cooperation service 120. In step S502, the MFP 110 attempts to log in to the MFP cooperation service 120 on the basis of the input authentication information. In step S503, the MFP cooperation service 120 verifies whether a user name and a password included in the login request are correct, and if the user name and the password are correct, returns an access token to the MFP 110. Subsequent requests made from the MFP 110 to the MFP cooperation service 120 are issued together with this access token, and a user of a processing target can be specified by this information. As a method of user authentication, authentication is performed by using a generally well known method (basic authentication, Digest authentication, authorization using OAuth, or the like).

The MFP 110 displays a scan setting screen in step S504 when the login process is completed. On the scan setting screen, the user performs settings related to reading through various types of scanning. When a paper form that is a scanning target is placed on the platen glass or the ADF by the user and a “scan start” button is pressed, the MFP 110 executes scanning in step S505 to generate digitized image data of the paper form. The MFP 110 transmits a scanned image analysis request to the MFP cooperation service 120 together with the image generated through the scanning process in step S506. When the MFP cooperation service 120 receives the scanned image analysis request, the image processing unit 432 of the MFP cooperation service 120 starts image analysis in step S507. Thereafter, the MFP cooperation service 120 returns “processId”, which is an identifier uniquely indicating the analysis requested to the MFP cooperation service 120, to the MFP 110 without waiting for the end of the image analysis process.

In step S508, the MFP cooperation service 120 classifies the scanned image by form type. Classification by the form type is performed on the basis of disposition information of a character region in the image. Specifically, the character region in the scanned image is extracted, a disposition thereof is compared with a disposition of a character region of the previously scanned image stored for each form type, an image having a similar disposition of the character region is specified, and the form type of the image is employed as a determination result.

In step S509, the MFP cooperation service 120 extracts a character string region that is an extraction target stored for each form type. This process will be referred to as a character string region extraction process.

In step S510, the MFP cooperation service 120 performs an OCR process on the extracted character string region. The OCR process is a technique for recognizing characters written in a region of interest in an image and converting the characters into text data.

In step S511, the MFP cooperation service 120 uses the character string obtained through the OCR process performed in step S510 to create a character string representing a file name and a folder path. Here, the file name is the name of a file created on the basis of the scanned image. The folder path is a folder path representing a cloud storage folder that is a storage destination of a file created on the basis of a scanned image. Here, the file name and the folder path are created according to a rule for creating a file name and a folder path, which are set in advance by the user for each form type. The rule defines a method of combining a character string extracted from a character string region in an image and a fixed character string specified by the user to create a file name and a folder path. For example, a rule such as file name: “{invoice number}.doc” and folder path: “/2018/{form type}/{company name}” is set. Here, it is assumed that a character string extracted from a specific character string region in an image corresponding to each wording is assigned each of parts of {invoice number}, {form type}, and {company name}. It is assumed that fixed character strings are assigned to the parts of “.doc” and “2018” without being changed. For example, it is assumed that character strings extracted from a character string region corresponding to {invoice number}, {form type}, and {company name} are “123-4567”, “invoice”, and “Shinagawa Co., Ltd.”. In this case, the file name and folder path are created as “123-4567.doc” and “/2018/invoice/Shinagawa Co., Ltd.”, respectively.

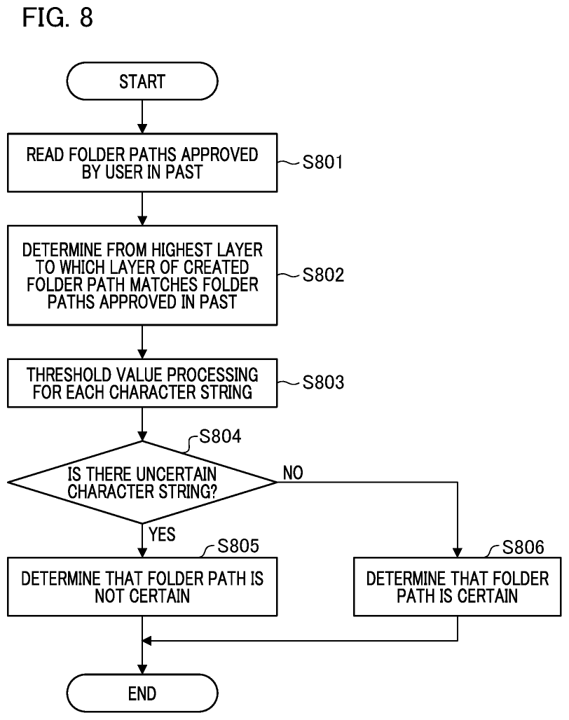

In step S512, the MFP cooperation service 120 determines whether or not automatic file transmission to the cloud storage 130 is possible. Here, the certainty of the created file name and folder path is evaluated, and only if it is determined that both are certain, both become automatic transmission targets. The certainty of the file name is evaluated on the basis of a certainty factor of results of the character string region extraction process and the OCR process for all the character strings extracted from the specific character string region in the image, forming the file name. The certainty factor represents the degree of certainty of the processing result as a real value from 0 to 1, and the greater the value, the larger the certainty. In this case, if the certainty factor of the results of the character string region extraction process and the OCR process for all the character strings is more than a preset threshold value (empirically determined value), it is determined that the file name is certain. A method of determining the certainty of the folder path will be described later with reference to a flowchart of FIG. 8.

In step S513, the MFP 110 periodically checks a processing status of the image analysis of “processId” to the MFP cooperation service 120 by using “processId” received in response to step S506. Here, the term “periodic” is, for example, every several hundred milliseconds to several milliseconds. Although not illustrated in the drawings, the process in step S513 is continuously performed until the response of the completion of image processing of the MFP cooperation service 120 can be obtained (until the timing of step S514). When the MFP cooperation service 120 receives the request for checking the processing status in step S513, it checks a processing status of “processId” and returns a response.

In the response to the processing status checking request, a character string indicating the current processing status (status) is stored in “status”. For example, when “status” is “processing”, it means that the process is being performed by the MFP cooperation service 120, and when “status” is “completed”, it means that the process has been completed. If the process fails, other statuses such as “status” being “failed” may be returned. A response when the process has been completed (when “status” is “completed”) includes information such as a result of analyzing the scanned image and the scan settings together with the status.

When the MFP 110 detects the completion of the process in step S514, the MFP 110 acquires the result information from the URL in which the result information included in the response is stored in step S515. If the analysis result is determined as showing “file automatic transmission is not possible”, checking or approval by the user is required, and thus the processes in step S516, step S517, step S518, and step S519 are executed. On the contrary, if the analysis result is determined as showing “file automatic transmission is possible”, the processes in steps S516 to S519 are not performed.

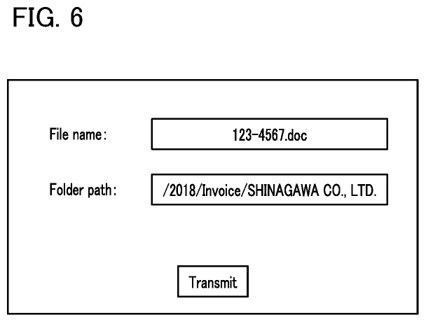

In step S516, the MFP 110 displays a file name/folder path setting screen as illustrated in FIG. 6 for setting the file name and the folder path of the file storage destination. The character strings created in step S511 are input in advance in the file name/folder path setting screen. After checking by the user, if it is determined that the character strings are correct, a “transmit” button is pressed and the character strings are approved. If it is determined that the character strings are incorrect, correct character strings are re-entered by the user on the setting screen, and then the “transmit” button is pressed for approval. When the “transmit” button is pressed, the MFP 110 transmits the character string region, the form type, the confirmed character string, and the user name used for each of the file name and the folder path in step S517 to the MFP cooperation service 120. The request control unit 431 of the MFP cooperation service 120 that has received various types of information requests the image processing unit 432 to store the various types of information in step S518. The image processing unit 432 stores the various types of information in the HDD 314 in step S519.

Thereafter, the MFP 110 transmits information such as a file name and a folder path to be set after converting the scanned image into a file to the MFP cooperation service 120 in step S520. When a request is received, the MFP cooperation service 120 starts a file generation process and returns to the MFP 110 that the request has been normally received. Upon receiving a transmission response, the MFP 110 finishes the process and returns to the scan setting screen display in step S504.

In step S521, the MFP cooperation service 120 acquires file format information to be transmitted to the cloud storage 130 from the scan settings registered in the MFP cooperation service, and generates a file from the scanned image on the basis of the settings. In step S522, the MFP cooperation service 120 sets the file generated in step S521 to the file name received in step S520, designates the folder path of the storage destination, and then transmits the file to the cloud storage 130.

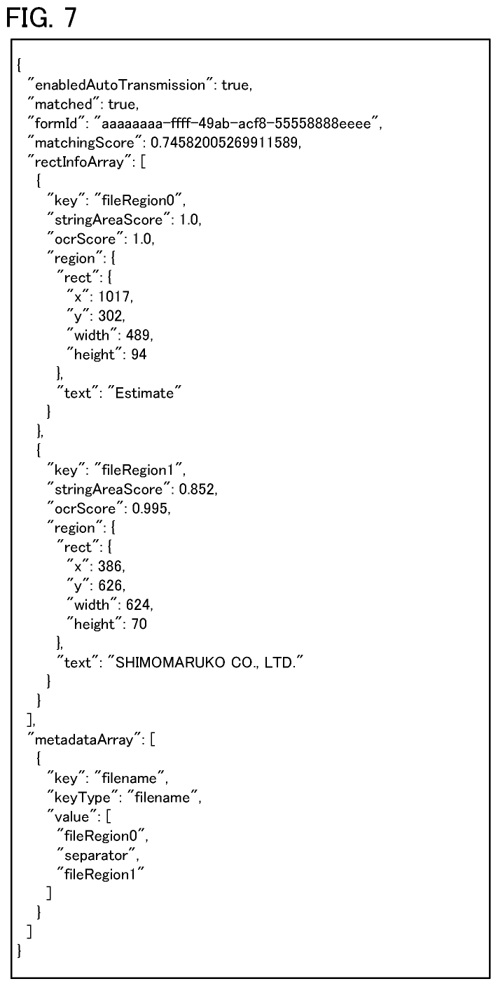

FIG. 7 is a diagram illustrating an example of a data structure stored in the analysis result storage process performed by the image processing unit in the present system.

“enabledAutoTransmission” stores a value indicating whether an analysis target image can be transmitted to the cloud storage 130 without checking or learning by the user due to automatic transmission determination. By referring to this value, the client PC 111 determines whether or not to automatically transmit a target form to the cloud storage.

“matched” stores a value indicating whether or not a form similar to the previously scanned image of the analysis target image is found through similar form determination.

In “formId”, if there is a similar form, a value uniquely indicating the form is stored, and if there is no similar form, a new value is issued.

In “matchingScore”, if there is a similar form, a value indicating the degree of similarity is stored. “matchingScore” indicates the degree of matching between disposition information of an image scanned in the past and disposition information of an image scanned this time as a real value from 0 to 1, and the greater the value, the more similar the form.

“rectInfoArray” stores information indicating the character string region of the analysis target image this time, which corresponds to the character string region previously used by the user when setting a file name and a folder path for the similar form. For example, it is assumed that an image was previously scanned and a file name and a folder path were set by using “estimate” and “Shinagawa Co., Ltd.” and the input results was learned. Thereafter, as a result of scanning a new image and determining a similar form to the scanned image, if it is determined as being a similar form, the input information is stored as automatic input target information below “rectInfoArray”. First, a character region that partially overlaps coordinate information of the character string region of the previously set “estimate” and “Shinagawa Co., Ltd.” is specified from the information stored in the HDD 314 of the MFP cooperation service 120 through the input result learning. Coordinate information and characters of the partially overlapping character region are stored in “text” that will be described later of “rectInfoArray”. A value uniquely indicating a character region used for automatic input is stored in “key”. “stringRegionScore” and “ocrScore” respectively store values indicating the certainty factors of results of the character string region extraction process and the OCR process. The certainty factor is expressed by a real value from 0 to 1, and the greater the value, the larger the certainty. “region” stores coordinate information of the character string region and characters extracted as a result of character recognition of the region. “rect” indicates coordinates of one extracted character string region. “x” is an X coordinate of the upper left of the region, “y” is a Y coordinate of the upper left of the region, “width” is the number of pixels in the X direction of the region, and “height” is the number of pixels in the Y direction of the region. “text” indicates characters extracted as a result of performing character recognition on the character region of “rect” through OCR.

“metadataArray” stores information indicating the order of the character string region used for the file name for automatically inputting the file name and a position where a delimiter is entered. If property information such as metadata is set in addition to the file name, necessary information is added to “rectInfoArray” or “metadataArray”. “key” stores a value uniquely indicating a setting value to be set in a scanned document. “keyType” stores a value indicating the type of the setting value of “key”. If used for a file name, “key” is “filename” and “keyType” is “filename”. “value” stores the character region used for the value of “key” and information regarding the delimiter. The example in FIG. 7 illustrates that the file name is automatically input in the order of the region having “key” of “fileRegion0”, the delimiter, and the region having “key” of “fileRegion1” in “rectInfoArray”.

FIG. 8 is a flowchart illustrating a flow of processes when evaluating the certainty of a folder path when the MFP cooperation service 120 determines whether or not a file can be automatically transmitted to the cloud storage 130. In the process according to this flowchart, program codes stored in the HDD 314 are loaded to the RAM 313 and executed by the CPU 311.

In step S801, the image processing unit 432 reads all folder paths (specific folder paths approved in the past) stored in the HDD 314 that have been approved by the user in the past. In step S802, the image processing unit 432 determines, with respect to the folder path created in step S511, from the highest layer to which layer matches the specific folder paths read in step S801. The image processing unit 432 determines prefix match of the folder path by determining the match from the highest layer. For example, it is assumed that the folder path created in step S511 is “/2018/invoice/Shinagawa Co., Ltd.”. It is assumed that “/2018/invoice/Kawasaki Co., Ltd.” is present in the file path read in step S801. In this case, the specific folder names in the respective layers up to “/2018/Invoice/” match. In this case, if there is no matching folder path up to the layer below “/2018/invoice/”, it is finally determined that “/2018/invoice/” is a matching part. The image processing unit 432 sets each character string of the folder path of the matching part as a character string representing a reliable folder name (a specific folder name approved by the user in the past).

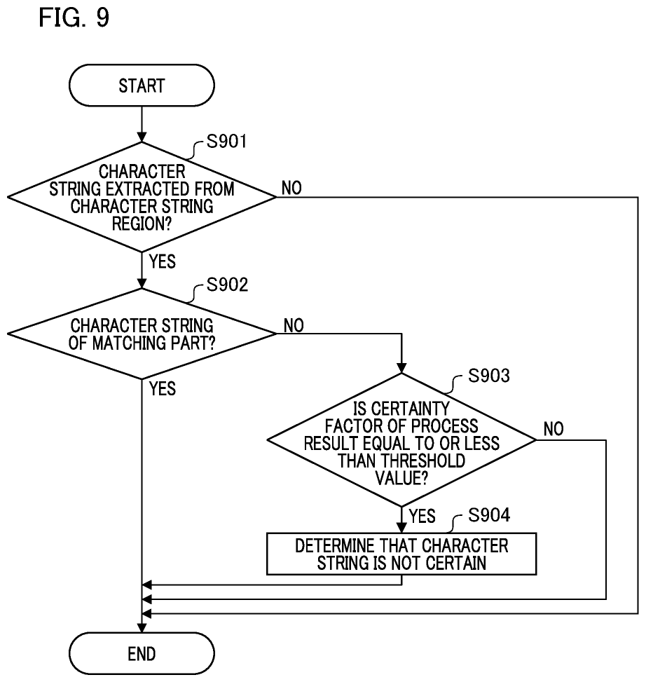

In step S803, the image processing unit 432 executes threshold value processing on the certainty factors of the results of the character string region extraction process and the OCR process for each character string forming the folder path. This process will be described later with reference to a flowchart of FIG. 9. In step S804, the image processing unit 432 determines whether or not an uncertain character string is present in the file path on the basis of the result in step S803. If an uncertain character string is present, the process proceeds to step S805, and if an uncertain character string is not present, the process proceeds to step S806. In step S805, the image processing unit 432 determines that the folder path is not certain. If the image processing unit 432 determines that the folder path is not certain, the folder path is set as a target for checking by the user. Also in each of the following processes, if the image processing unit 432 determines that the folder path or the character string is not certain, the folder path or the character string is a target for checking by the user. In step S806, the image processing unit 432 determines that the folder path is certain and is automatically approved.

FIG. 9 is a flowchart illustrating a detailed flow of the threshold value processing executed in step S803. In the process according to this flowchart, the program codes stored in the HDD 314 are loaded to the RAM 313 and executed by the CPU 311. The processes from step S901 to step S904, that is, the processes in step S901, step S902, step S903, and step S904 are performed on each character string forming the file path. For example, in the folder path “/2018/Invoice/Kawasaki Co., Ltd.”, a process is performed on each of the character strings “2018”, “Invoice”, and “Kawasaki Co., Ltd.”.

In step S901, the image processing unit 432 determines whether the target character string is a character string extracted from the character string region in the scanned image. If the target character string is a character string extracted from the character string region, the process proceeds to step S902, and if not, the process proceeds to the end point of step S904. In the examples of “2018”, “invoice”, and “Kawasaki Co., Ltd.”, since “2018” is a fixed character string specified by the user, the process proceeds to the end point of step S904. In the examples of “2018”, “invoice”, and “Kawasaki Co., Ltd.”, since “invoice” and “Kawasaki Co., Ltd.” are character strings extracted from the character string region, the process proceeds to step S902.

In step S902, the image processing unit 432 determines whether or not the target character string is a character string determined as matching in step S802. If the target character string is a matching character string, the process proceeds to the end point of step S904, and if not, the process proceeds to step S903.

In step S903, the image processing unit 432 determines whether or not certainty factors of the results of the character string region extraction process executed in step S509 and the OCR process executed in step S510 are equal to or less than a preset threshold value (empirically determined value). If the certainty factors are equal to or less than the threshold value, the process proceeds to step S904, and if not, the process proceeds to the end point of step S904. In step S904, the image processing unit 432 determines that the target character string is an uncertain character string.

As described above, according to the present embodiment, when the scan data is transmitted to an external storage, the frequency of checking by the user for the folder path of the storage destination can be reduced, and efficiency of a process can be improved. According to the present embodiment, if a middle part of a folder path matches a folder path entered or approved by a user in the past, it is possible to reduce the frequency of visual checking by the user by taking into consideration that the matching part is likely to be a correct folder path. According to the present embodiment, a folder path created on the basis of a character string obtained through the OCR process is compared with a folder path entered or approved by the user in the past. As a result of this comparison, a character string of a matching part can be excluded from the threshold value processing related to certainty factors of the character string region extraction process and OCR process performed to determine whether or not automatic transmission is possible, and thus it is possible to reduce the frequency of visual checking by the user.

### Second Embodiment

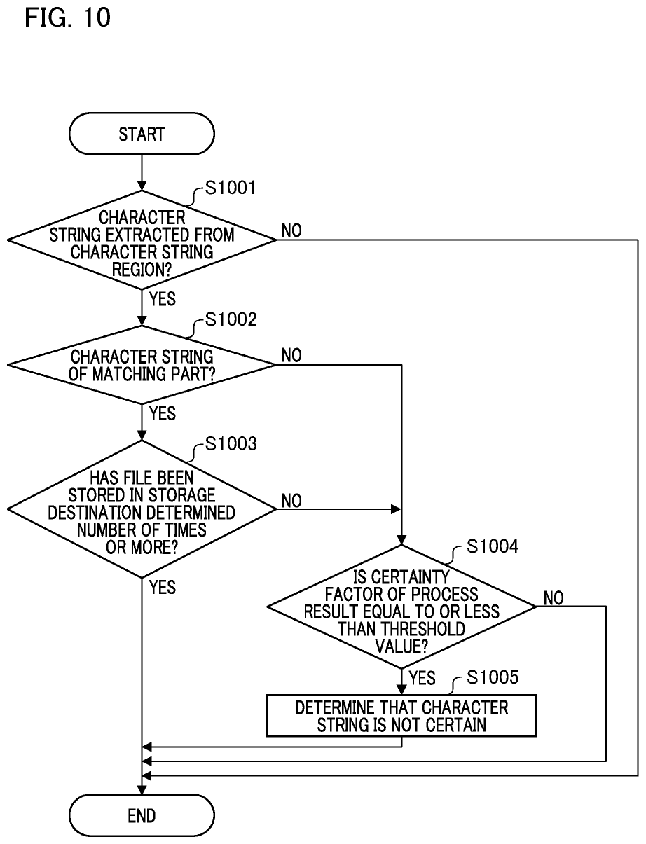

In the first embodiment, if a middle part of a created folder path matches a folder path approved by a user in the past, a character string of a matching part is excluded from a threshold value processing target, and thus the frequency of checking by the user is reduced. In this case, even with respect to the character string of the matching portion, there is a probability that an incorrect character string may be obtained depending on cases, and the problem is solved in the second embodiment. In the first embodiment, the process in FIG. 9 is executed in step S803 in FIG. 8, but in the second embodiment, a process in FIG. 10 is executed instead of the process in FIG. 9 in step S803.

Here, a detailed flow of the threshold value processing executed in step S803 in the second embodiment will be described with reference to FIG. 10. In the process according to this flowchart, program codes stored in the HDD 314 are loaded to the RAM 313 and executed by the CPU 311. Since a system configuration and a processing procedure of the present embodiment are the same as those described in the first embodiment, the description thereof will be omitted and only different parts will be described. Specifically, since steps S1001 to S1002 and steps S1004 to S1005 are the same as steps S901 to S902 and steps S903 to S904, the description thereof will be omitted.

In step S1003, the image processing unit 432 refers to the information stored in the HDD 314 in step S519, and determines whether or not the file has been stored a predetermined number of times or more below the folder layer represented by the target character string. If the file has been stored the predetermined number of times or more, the process proceeds to the end point of step S1005, and if not, the process proceeds to step S1004. Here, only a folder name of a folder in which the file has been stored the predetermined number of times or more is determined as being a certain folder name, and only if the target character string matches the folder name, the folder name is intended to be excluded from a threshold value processing target.

According to the method described in the present embodiment, even if a middle part of a created folder path matches a folder path approved by a user in the past, if a character string of a matching part is not certain, it is possible not to exclude the character string from a threshold value processing target.

### Third Embodiment

In the first embodiment, if a middle part of a created folder path matches a folder path approved by a user in the past, a character string of a matching part is excluded from a threshold value processing target, and thus the frequency of checking by the user is reduced.

In the second embodiment, even if a middle part of a created folder path matches a folder path approved by a user in the past, if a character string of a matching part is not certain, the character string is not excluded from a threshold value processing target.

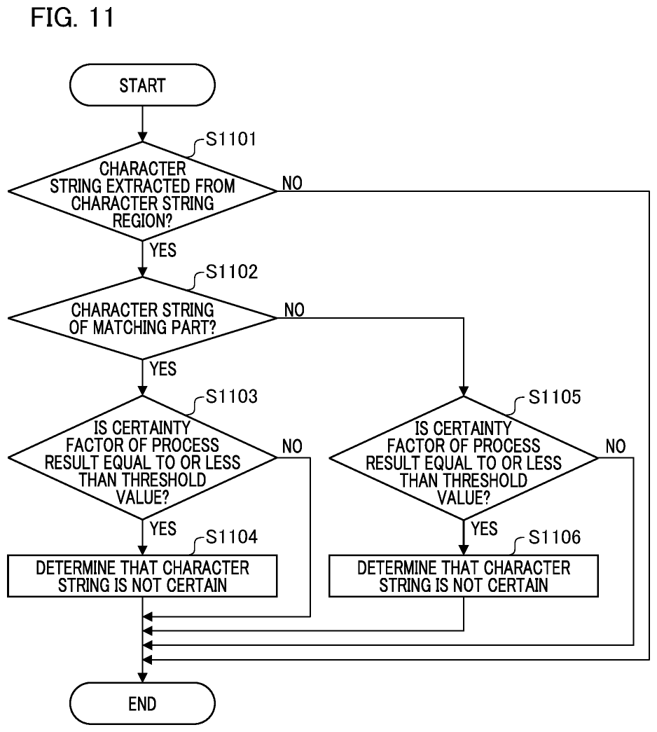

However, there is a case where the method of the second embodiment cannot be used among cases where a character string of a matching part is not certain. For example, although a target character string is a character string that matches the folder name of a folder in which a file has been stored a predetermined number of times or more, there may be a case where a result of a character string region extraction process or an OCR process performed when the character string is created is likely to be incorrect. The third embodiment copes with such a case. In the first embodiment, the process in FIG. 9 is executed in step S803 in FIG. 8, but in the third embodiment, the process in FIG. 11 is executed instead of the process in FIG. 9 in step S803.

Here, a detailed flow of the threshold value processing executed in step S803 in the third embodiment will be described with reference to FIG. 11. In the process according to this flowchart, program codes stored in the HDD 314 are loaded to the RAM 313 and executed by the CPU 311. Since a system configuration and a processing procedure of the present embodiment are the same as those described in the first embodiment, the description thereof will be omitted and only different parts will be described. Specifically, since steps S1101 to S1102 and steps S1105 to S1106 are the same as steps S901 to S902 and steps S903 to S904, the description thereof will be omitted.

In step S1103, the image processing unit 432 determines whether or not certainty factors of the results of the character string region extraction process executed in step S509 and the OCR process executed in step S510 are equal to or less than a preset threshold value. If the certainty factors are equal to or less than the threshold value, the process proceeds to step S1104, and if not, the process proceeds to the end point of step S1104. The threshold value used in step S1105 is an example of a first threshold value. The threshold value used in step S1103 is an example of a second threshold value. It is assumed that the threshold value used in step S1103 is less than the threshold value used in step S1105. While taking into consideration that there is a high probability that a character string of a matching part is a correct character string by using a smaller threshold value used for the character string of the matching part than for the other character strings, if the certainty factor of the result of the character string region extraction process or the OCR process is extremely low, the user can check the character string. In this case, if a user who approved the matching character string in the past is the same user as an operator, it may be determined that there is a higher probability of a certain character string, and a smaller threshold value may be used.

In step S1104, the image processing unit 432 determines that the target character string is an uncertain character string.

According to the method described in the present embodiment, if there is a high probability that the result of the character string region extraction process or the OCR process is incorrect even for the character string that matches the folder name approved by the user in the past, the user can be made to check the character string.

### Fourth Embodiment

In the first to third embodiments, depending on whether or not a created folder path matches a folder path approved by a user in the past, it is determined whether or not the folder path is present in a storage that is a storage destination. However, if a folder structure of the storage can be inquired about, the certainty of determination is higher in that method. In the fourth embodiment, the certainty of determination as to whether or not a folder path is present is increased by inquiring about a folder structure of the storage.

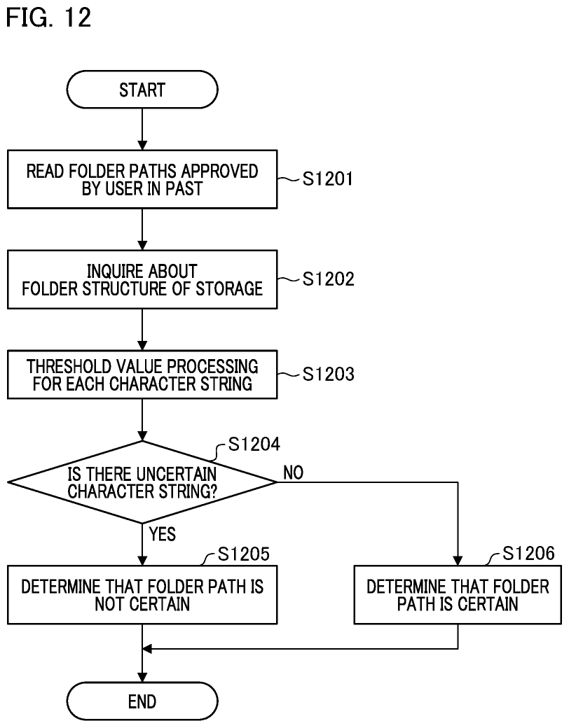

Here, details of the automatic transmission determination process performed by the image processing unit 432 of the MFP cooperation service 120 in the fourth embodiment will be described with reference to FIG. 12. In the process according to this flowchart, program codes stored in the HDD 314 are loaded to the RAM 313 and executed by the CPU 311. Since a system configuration and a processing procedure of the present embodiment are the same as those described in the first embodiment, the description thereof will be omitted and only different parts will be described. Specifically, since steps S1201 and steps S1203 to S1206 are the same as steps S801 and steps S803 to S806, the description thereof will be omitted.

In step S1202, the image processing unit 432 inquires the cloud storage 130 about a folder structure via the network I/F 315.

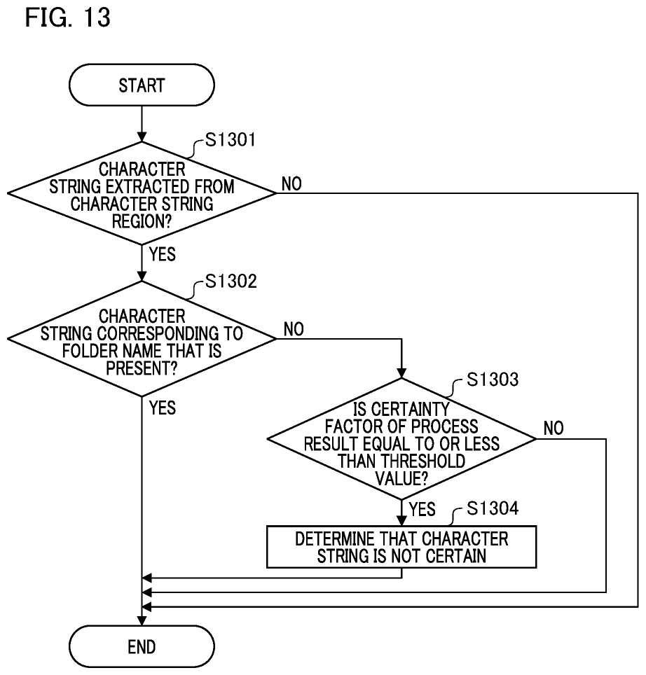

Next, a detailed flow of the threshold value processing executed in step S1203 in the fourth embodiment will be described with reference to FIG. 13. In the process according to this flowchart, program codes stored in the HDD 314 are loaded to the RAM 313 and executed by the CPU 311. Since a system configuration and a processing procedure of the present embodiment are the same as those described in the first embodiment, the description thereof will be omitted and only different parts will be described. Specifically, since steps S1301 and steps S1303 to S1304 are the same as steps S901 and steps S903 to S904, the description thereof will be omitted.

In step S1302, the image processing unit 432 refers to the folder structure of the storage inquired about in step S1202, and determines whether or not the target character string is a character string corresponding to an actually present folder name. If the target character string is a character string corresponding to a present folder name, the process proceeds to the end point of step S1304, and if not, the process proceeds to step S1303.

According to the method described in the present embodiment, by inquiring about a folder structure of the storage, it is possible to increase the certainty of determination as to whether or not a folder path is present.

### Fifth Embodiment

In the first to fourth embodiments, if a middle part of a created folder path matches a folder path approved by a user in the past or a folder path of which the presence can be checked, the presence or absence of threshold value processing or threshold values are switched therebetween for a character string of a matching part. However, if there is another folder path having a folder name similar to the character string of the matching part, it may be dangerous to exclude the character string from the threshold value processing target or to use a small threshold value. This is because there is a probability that a correct result of an OCR process for such a character string is a character string corresponding to a similar folder name. In the fifth embodiment, a character string corresponding to a folder name to which a similar folder name is considered to be present is not excluded from a threshold value processing target, and a threshold value having the same value as that of other character strings is used, and thus a user is made to check the character string as necessary.

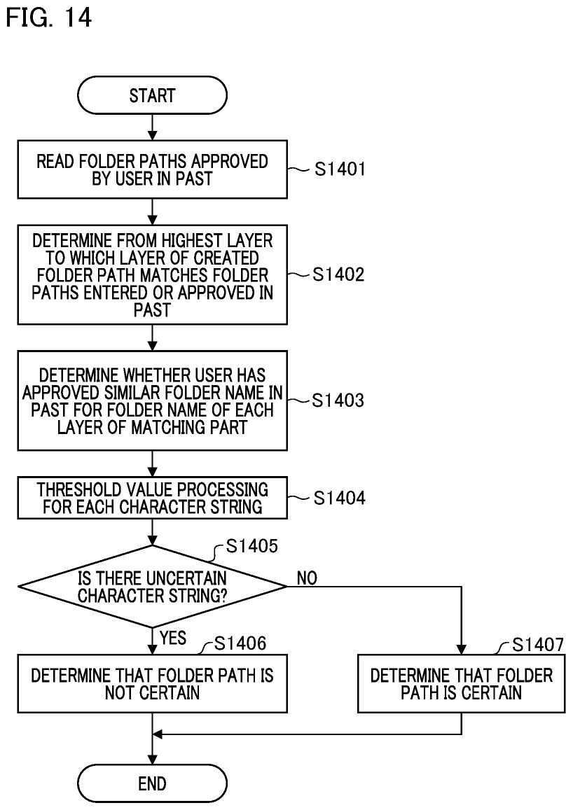

Here, details of the automatic transmission determination process performed by the image processing unit 432 of the MFP cooperation service 120 in the fifth embodiment will be described with reference to FIG. 14. In the process according to this flowchart, program codes stored in the HDD 314 are loaded to the RAM 313 and executed by the CPU 311. Since a system configuration and a processing procedure of the present embodiment are the same as those described in the first embodiment, the description thereof will be omitted and only different parts will be described. Specifically, since steps S1401 to S1402 and steps S1404 to S1407 are the same as steps S801 to S802 and steps S803 to S806, the description thereof will be omitted.

In step S1403, the image processing unit 432 determines whether the user has approved a similar folder name in the past for the folder name of each layer corresponding to the character string of the matching part determined in step S1403. In this case, whether or not the two folder names are similar is determined by using an index indicating the degree of similarity of the character strings, such as the Levenshtein distance, and depending on whether or not the index is equal to or less than a predetermined threshold value.

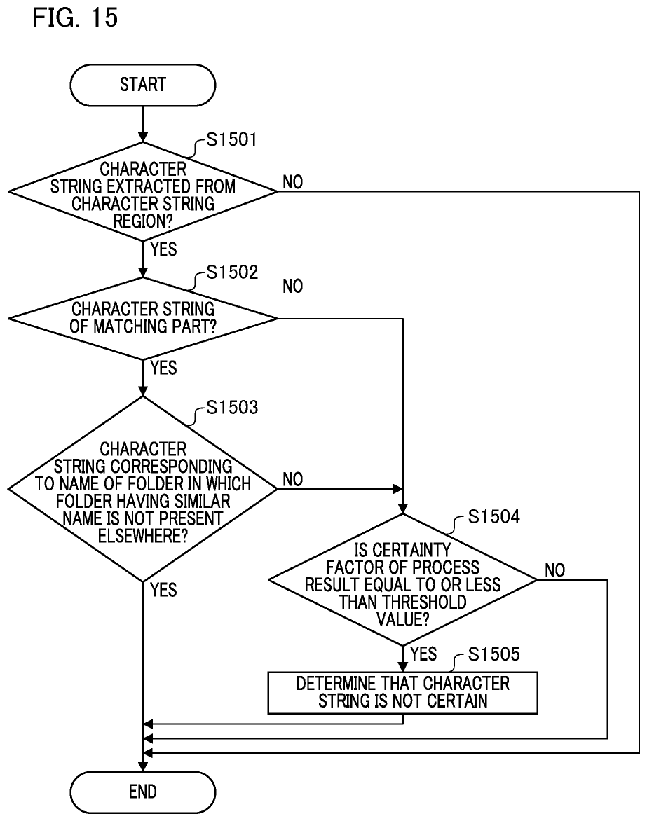

Next, a detailed flow of the threshold value processing executed in step S1404 in the fifth embodiment will be described with reference to FIG. 15. In the process according to this flowchart, program codes stored in the HDD 314 are loaded to the RAM 313 and executed by the CPU 311. Since a system configuration and a processing procedure of the present embodiment are the same as those described in the first embodiment, the description thereof will be omitted and only different parts will be described. Specifically, since steps S1501 to S1502 and steps S1504 to S1505 are the same as steps S901 to S902 and steps S903 to S904, the description thereof will be omitted.

In step S1503, the image processing unit 432 determines, on the basis of the result of the process in step S1403, whether or not the target character string is a character string corresponding to the name of a folder in which a folder having a similar name is not present elsewhere. If the target character string is a corresponding character string, the process proceeds to the end point of step S1505, and if not, the process proceeds to step S1504.

According to the method described in the present embodiment, a character string corresponding to a folder name to which a similar folder name is considered to be present is not excluded from a threshold value processing target, and a user can be made to check the character string as necessary by using a threshold value having the same value as that of other character strings.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-072754, filed Apr. 22, 2021, which is hereby incorporated by reference herein in its entirety.

What is claimed is:

1. An image processing apparatus comprising:
one or more memories that store instructions; and
one or more processors configured to execute the instructions stored in the one or more memories to:
acquire image data;
perform a character recognition process on the acquired image data to detect a character string, and create a folder path indicating a storage destination of the acquired image data including one or more of the detected character strings; and
determine whether or not each of the character strings forming the created folder path is a character string representing a specific folder name, determine whether or not a certainty factor of a result of the character recognition process for a character string determined as not being a character string representing the specific folder name is equal to or less than a threshold value, and if there is at least one character string for which determination of being equal to or less than the threshold value has been made, set the created folder path as a target for checking by a user.

2. The image processing apparatus according to claim 1, wherein
the specific folder name is a folder name forming a folder path approved by the user in the past.

3. The image processing apparatus according to claim 1, wherein
the specific folder name is a folder name forming a folder path approved by the user in the past, and is a folder name forming a folder path in which a file has been stored a predetermined number of times or more below a folder layer of the folder path approved by the user in the past.

4. The image processing apparatus according to claim 1, wherein
the specific folder name is a folder name of a folder present in a folder structure obtained by inquiring the storage destination of the image data about the folder structure.

5. The image processing apparatus according to claim 1, wherein
the specific folder name is a folder name forming a folder path approved by the user in the past, and is a folder name of a folder in which a folder having a similar folder name is not present in the same layer.

6. An image processing apparatus comprising:
one or more memories that store instructions; and
one or more processors configured to execute the instructions stored in the one or more memories to:
acquire image data;
perform a character recognition process on the acquired image data to detect a character string, and create a folder path indicating a storage destination of the acquired image data including one or more of the detected character strings; and
determine whether or not each of the character strings forming the created folder path is a character string representing a specific folder name, determine whether or not a certainty factor of a result of the character recognition process for a character string determined as not being a character string representing the specific folder name is equal to or less than a first threshold value, determine whether or not a certainty factor of a result of the character recognition process for a character string determined as being a character string representing the specific folder name is equal to or less than a second threshold value, and if there is at least one of a character string for which determination of being equal to or less than the first threshold value has been made and a character string for which determination of being equal to or less than the second threshold value has been made, set the created folder path as a target for checking by a user.

7. The image processing apparatus according to claim 6, wherein
the specific folder name is a folder name forming a folder path approved by the user in the past.

8. The image processing apparatus according to claim 6, wherein
the specific folder name is a folder name forming a folder path approved by the user in the past, and is a folder name forming a folder path in which a file has been stored a predetermined number of times or more below a folder layer of the folder path approved by the user in the past.

9. The image processing apparatus according to claim 6, wherein
the specific folder name is a folder name of a folder present in a folder structure obtained by inquiring the storage destination of the image data about the folder structure.

10. The image processing apparatus according to claim 6, wherein
the specific folder name is a folder name forming a folder path approved by the user in the past, and is a folder name of a folder in which a folder having a similar folder name is not present in the same layer.

11. An image processing method comprising:
acquiring image data;
extracting a character string region from the acquired image data, performing a character recognition process on the extracted character string region to detect a character string, and creating a folder path indicating a storage destination of the acquired image data including one or more of the detected character strings; and
determining whether or not each of the character strings forming the created folder path is a character string representing a specific folder name, determining whether or not a certainty factor of a result of the character recognition process for a character string determined as not being a character string representing the specific folder name is equal to or less than a threshold value, and if there is at least one character string for which determination of being equal to or less than the threshold value has been made, setting the created folder path as a target for checking by a user.

12. An image processing method comprising:
acquiring image data;
extracting a character string region from the acquired image data, performing a character recognition process on the extracted character string region to detect a character string, and creating a folder path indicating a storage destination of the acquired image data including one or more of the detected character strings; and
determining whether or not each of the character strings forming the created folder path is a character string representing a specific folder name, determining whether or not a certainty factor of a result of the character recognition process for a character string determined as not being a character string representing the specific folder name is equal to or less than a first threshold value, determining whether or not a certainty factor of a result of the character recognition process for a character string determined as being a character string representing the specific folder name is equal to or less than a second threshold value, and if there is at least one of a character string for which determination of being equal to or less than the first threshold value and a character string for which determination of being equal to or less than the second threshold value has been made, setting the created folder path as a target for checking by a user.

13. A non-transitory storage medium that stores a program that causes a computer to execute an image processing method, the image processing method comprising:
acquiring image data;
extracting a character string region from the acquired image data, performing a character recognition process on the extracted character string region to detect a character string, and creating a folder path indicating a storage destination of the acquired image data including one or more of the detected character strings; and
determining whether or not each of the character strings forming the created folder path is a character string representing a specific folder name, determining whether or not a certainty factor of a result of the character recognition process for a character string determined as not being a character string representing the specific folder name is equal to or less than a threshold value, and if there is at least one character string for which determination of being equal to or less than the threshold value has been made, setting the created folder path as a target for checking by a user.

14. A non-transitory storage medium that stores a program that causes a computer to execute an image processing method, the image processing method comprising:
acquiring image data;
extracting a character string region from the acquired image data, performing a character recognition process on the extracted character string region to detect a character string, and creating a folder path indicating a storage destination of the acquired image data including one or more of the detected character strings; and
determining whether or not each of the character strings forming the created folder path is a character string representing a specific folder name, determining whether or not a certainty factor of a result of the character recognition process for a character string determined as not being a character string representing the specific folder name is equal to or less than a first threshold value, determining whether or not a certainty factor of a result of the character recognition process for a character string determined as being a character string representing the specific folder name is equal to or less than a second threshold value, and if there is at least one of a character string for which determination of being equal to or less than the first threshold value has been made and a character string for which determination of being equal to or less than the second threshold value has been made, setting the created folder path as a target for checking by a user.
